(19) United States
(12) Patent Application Publication
(10) Pub. No.: US 2023/0103625 A1
(43) Pub. Date: Apr. 6, 2023

(54) METHOD AND SYSTEM FOR DRIVER NOTIFICATION AND DRIVER REGISTRY SERVICE

(71) Applicant: YUSTOPME, LLC, Louisville, KY (US)

(72) Inventor: Ronald David Burrell, Louisville, KY (US)

(21) Appl. No.: 17/938,044

(22) Filed: Oct. 4, 2022

Related U.S. Application Data
(60) Provisional application No. 63/262,091, filed on Oct. 4, 2021.

(51) Int. Cl. G06Q 50/26

(52) U.S. Cl. CPC G06Q 50/26

(57) ABSTRACT

The invention relates to a system and method that allows for police officers to communicate with drivers who have registered with a drivers registry. In this manner the driver is alerted that the stop is by an officer of the law and allows the driver and officer to communicate prior the officer leaving his/her police cruiser. The invention provides a reduced stress experience during traffic stops and keeps situations from escalating.

### FIELD OF THE INVENTION

The invention generally relates to the field of law enforcement notification services and driver registry services. More specifically, the invention relates to the field of providing driver notification via a centralized law enforcement agency.

### BACKGROUND OF THE INVENTION

There exists increasing anxiety in many communities associated with police/driver interactions. A great need is felt in many communities to decrease fear and tension concerning police traffic stops and other interventions.

What is needed is a system that promotes exchange of information between police and state agencies and the community and in particular between drivers and officers during traffic stops.

### SUMMARY OF THE INVENTION

The present invention provides a method and a system that allows for drivers to register with local authorities allowing police officers to contact drivers during traffic stops to confirm they are police officers and the nature of the stop without leaving their vehicle. This is particularly useful on dark nights, in unlit surrounding or in rainy conditions or other situations where drivers have difficulty confirming the identity of the person pulling them over.

In one exemplary embodiment, the invention provides a (Local) Police Driver Notification system (“LPDN” or “DNS”) integrated with either or both of a central service provider or a client-operated LPDN system, which may be connected to one or more databases, e.g., operated by a central service provider for assisting in the operation and maintenance of the LPDN system. The central service or facility may comprise one or more servers in communication with one or more access devices (e.g., officer operated or part of an officer cruiser vehicle), and one or more mobile devices (e.g., driver operated devices (such as a mobile phone or communication device) associated with a driver account subscribed via the driver registry system).

In one implementation, the present invention is provided as a web-based or cloud-based software-as-a-service (SaaS) system wherein the system may be accessed via a network by the officer access devices and driver mobile devices. The LPDN system may include a LPDN server and user interface operating on officer access device. The user interface may be a web browser such as Microsoft Internet Explorer®, an independent application running on the officer access device, or a mobile “app” running on one of the officer access devices and driver mobile devices. In this embodiment, the present invention provides for the notification of drivers based on driver profiles stored in the registry database, which may be a subscriber database co-located with the LPDN server or may be a separate agency-maintained database (e.g., state department of transportation “DOT”) accessible via a communications network, e.g., database housed in a license database and/or as stored in a separate third-party provided database. The registry databases may be stored on or accessed by a database server.

The registry database may comprise a combination of internal, external, and/or third-party databases. For example, multiple states participating in the LPDN-based service may share or exchange driver information to allow for a broader cross-jurisdiction notification system. The database server may also include additional databases relating to subscriber information, mapping information, and vehicle video recording systems to provide enhanced services. The other databases may be accessible for use by system to manage and track driver notifications. Interactions between police and drivers may, alternatively, be recorded for later replay.

Registry databases, which take the exemplary form of one or more electronic, magnetic, or optical data-storage devices, include or are otherwise associated with respective indices. Each of the indices includes terms and phrases in association with corresponding document addresses, identifiers, and other conventional information. Registry databases are coupled or couplable via a wireless or wireline communications network, such as a local-, wide-, private-, or virtual-private network, to a central server.

A central server is generally representative of one or more servers for providing LPDN functionality through one or more service modules to officers and drivers and may include a processor module, a memory module, a subscriber database, a driver database, an LPDN service interface, and an “other jurisdictions” interface. Processor module includes one or more local or distributed processors, controllers, or virtual machines. Memory module, which takes the exemplary form of one or more non-transitory electronic, magnetic, or optical data-storage devices, stores a subscriber database, which may be loaded from an external database such as driver/notification database, a driver database, an LPDN service interface, and an “other jurisdictions interface. The LPDN service interface comprises a set of commands and functions for managing driver notification services by the LPDN system. The “Other Jurisdictions Interface” module comprises a set of commands and functions that facilitate interaction of LPDN system with LPDN systems operated by other jurisdictions (e.g., other states or cities or counties) which may be stored locally in the server 120 or may be loaded from the database server. The Subscriber Database may comprise registry capabilities to directly enroll drivers into the LPDN system and may comprise a set of commands and functions that implement registry and management functionality although this may be handled via separate agency functions, e.g., DOT.

Subscriber database is an optional component of the central sever and may include subscriber-related data for controlling, administering, and managing membership or subscription-based access of registry database(s). In the exemplary embodiment, subscriber database includes one or more user preference (or more generally user) data structures. In the exemplary embodiment, one or more aspects of the user data structure relate to user customization of various communication and interface options stored as user stored data. User data also includes user ID, subscription data, user preferences, and external user stored data. LPDN server may include one or more search engines and related user-interface components, for receiving and processing user queries against one or more of databases.

The officer access device is generally representative of one or more access devices operated by officer responsible for traffic control or patrol. In the exemplary embodiment, access device takes the form of a personal computer, workstation, personal digital assistant, mobile telephone, or any other device capable of providing an effective user interface with a server or database. Specifically, access device includes a processor module, a memory, a display, a keyboard, and a graphical pointer or selector. In the exemplary embodiment, processor module takes any convenient or desirable form and includes one or more processors, processing circuits, or controllers. Coupled to processor module is memory. Memory stores code (machine-readable or executable instructions) for an operating system, a browser, and scheduling and management software.

In one exemplary embodiment, operating system takes the form of a version of the Microsoft Windows operating system, and browser takes the form of a version of Microsoft Internet Explorer. Operating system and browser not only receive inputs from keyboard and selector, but also support rendering of graphical user interfaces on display. In some embodiments, display may be a touch-screen display and may also serve to receive user inputs. Upon executing LPDN application by processor, a LPDN interface integrated into the graphical-user interface of the application software is defined in memory and rendered or presented on display. Upon rendering, interface presents data in association with one or more interactive control features (or user-interface elements) which is stored in memory as API. The LPDN interface may also be loaded into the user interface of the browser.

An exemplary embodiment of the LPDN system may include a central state (police or department of transportation or licensing) database, e.g., state license agency, connected to a server for deploying a web-based driver notification system. The system is managed, e.g., by a state or other governmental agency, e.g., police department, and is connected via a communications network to a police officer operating a remote access device, such as a remote device in the possession of an officer or fixed to a police cruiser. When a police officer pulls over a motorist the officer inputs the vehicle license information over a communications network to access a database to determine if the vehicle and an associated owner of the vehicle is registered to the LPDN system. A database lookup is initiated to see if the license tag matches a driver record stored on the database. If a match is found then the officer is presented with contact information to contact the owner of the vehicle and presumed operator of the vehicle. The office or central server contacts the owner of the vehicle based on information and permissions given by the owner and included in the owner profile data structure. The owner is contacted, e.g., by a phone call from the officer or a text from the officer or by similar means from the central server facility. For example a dispatcher may initiate the call instead of the officer and may report back to the officer whether the vehicle is associated with a record stored in the LPDN database.

The driver or owner of the vehicle is contacted and alerted to the fact the person pulling them over is in fact an officer associated with a state or other agency of the government. The contact may be a phone call directly from the officer operating the police vehicle involved in the traffic stop and the communication may be direct between the officer and the owner of the vehicle. If the owner is operating the vehicle being pulled over then there is direct communication between the driver and officer. The officer then communicates to the driver the reason for the stop, e.g., speeding, traffic light, stop sign infraction or other event. This gives the driver a way of confirming the purpose and authorized nature of the traffic stop. The LPDN may also track the event, i.e., traffic stop, along with driver/officer interaction. This will help to deescalate and remove tension associated with what can be a stressful event.

In the event the owner associated with the vehicle is not the driver, then the owner may confirm the person who has possession of the vehicle and the authorized nature of the possession or not. The record associated with the vehicle may also include an other authorized user, e.g., a family member, and may also include contact information for other authorized operators. The record may also include other pertinent information including health or other issues associated with the owner or authorized driver.

In another embodiment the invention provides a method for facilitating communications between a police officer and a driver during a traffic stop. For example, the method may include a police officer pulling over a vehicle and driver during a typical traffic stop; the police officer and/or dispatcher operating a LPDN application to reach out to a registered owner/operator of the stopped vehicle; the officer inputs the license tag of the vehicle or calls in the information to a dispatcher; either the officer or the dispatcher checks the LPDN database to see if the vehicle is registered; and if so accesses the contact information provided by the owner/operator. The LPDN information and subscriber record may be part of the vehicle registration process or licensing process to facilitate participation.

An LPDN subscriber interface according to the present invention allows an administrator to add an owner/driver to the LPDN system and database or an associated database. The owner's personal information is entered in the personal information fields and may include first and last name, address, city, state, and zip code, phone number, if texts are available, personal email, vehicle license tag/number, vehicle type, owner driver's license number, and state issuing license tag and/or driver's license. Additional other authorized driver information fields are provided and may include name, address, city, state, and zip code, driver's license number, relationship, and other data. In the additional information fields, information such as the availability of an iPad, smartphone, vehicle-based communication, and LPDN membership information may be indicated. The fields may also be provided to the officer or may only visible by a displatcher.

The LPDN system may include an LPDN Driver Notification interface and LPDN Officer Interface adapted to present the owner/operator with the office name and present a message, e.g., “As a LPDN member you are being notified of a request to communicate with you concerning a traffic stop.” The owner/operator may respond with agreeing to the request, confirming they are actually operating the stopped vehicle, and preferred contact method. The officer is presented with an interface screen confirming the driver's identity, that they agree to communicate with the officer via the LPDN system, the phone number of other contact data, the LPDN driver's license number and allowing the officer to communicate a message, e.g., text message concerning the reason for the stop.

Exemplary embodiments of the present invention are provided in more detail below.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIG. 1 is a representative network diagram of the components involved in a first embodiment of the invention.

FIG. 2 is a schematic diagram showing communication flow in connection with the driver notification and management system according to the present invention.

FIG. 3 is an illustration of a traffic stop and communications protocol associated with notification system of the present invention.

FIG. 4 is a screenshot of a driver subscriber interface associated with a driver registry system in accordance with the present invention.

FIG. 5 is a screenshot of an exemplary driver notification communication associated with a traffic stop.

FIG. 6 is a screenshot of an exemplary police officer communication showing responsive information received from a driver associated with a traffic stop.

### DETAILED DESCRIPTION OF THE INVENTION

The present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

The present invention provides for a Local Police Driver Notification (“LPDN”) system. The invention relates to a system and method that allows for police officers to communicate with drivers who have registered with a drivers registry. In this manner the driver is alerted that the stop is by an officer of the law and allows the driver and officer to communicate prior the officer leaving his/her police cruiser. The invention provides a reduced stress experience during traffic stops and keeps situations from escalating.

The driver notification and management system of the present invention promotes safe pullover initiations by law enforcement and assures safety for the officer during a stop and reduced tension and increased safety for the driver being stopped. Upon entering the license tag information the system checks a driver registry and provides driver information to the officer and allows direct communication to keep matters calm without leaving the police cruiser. This may be particularly beneficial to women pulled over and not knowing for certain who is pulling them over and what the purpose is for the stop.

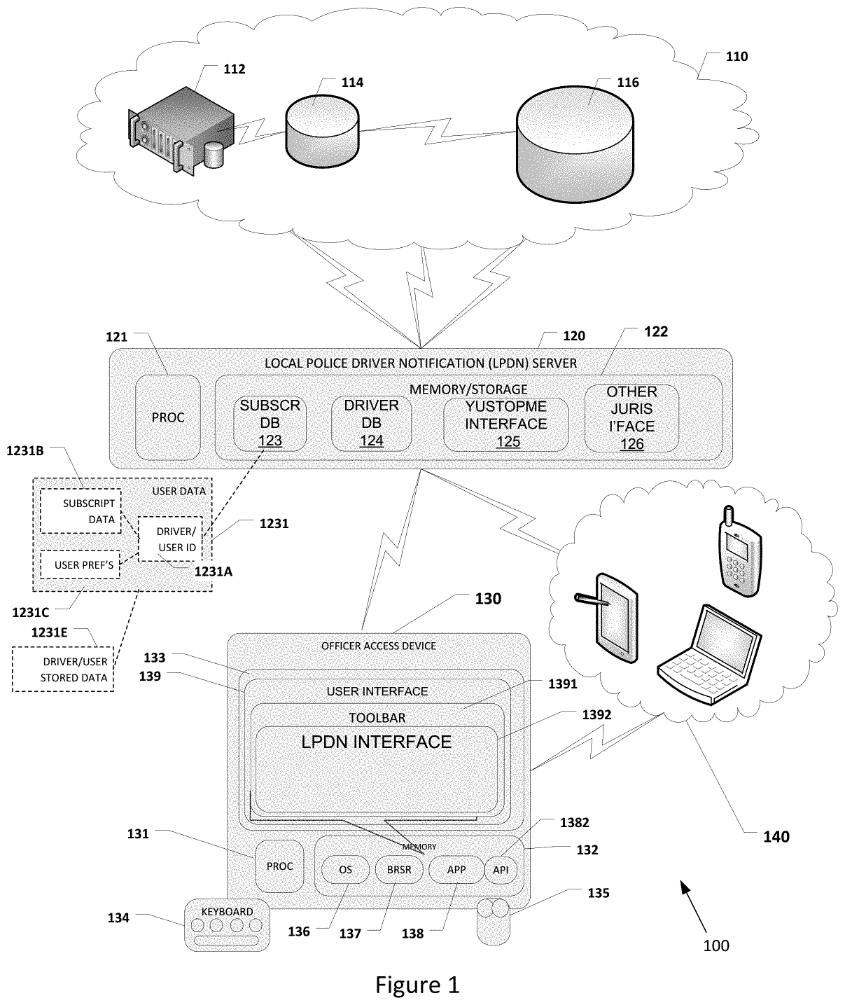

With reference now to FIG. 1, an exemplary Local Police Driver Notification system (“LPDN” or “DNS”) 100 is adapted to integrate with either or both of a central service provider 110 or a client-operated LPDN system 100 as depicted. System 100 may be connected to one or more databases 110, e.g., operated by a central service provider for assisting in the operation and maintenance of the LPDN system 100, which may comprise one or more servers 120 in communication with one or more access devices 130 (e.g., officer operated or part of an officer cruiser vehicle), and one or more mobile devices 140 (e.g., driver operated devices associated with a driver account subscribed via the driver registry system).

In one implementation, the present invention is provided as a web-based or cloud-based software-as-a-service (SaaS) system wherein the system may be accessed via a network by the officer access devices 130 and driver mobile devices 140. As illustrated in FIG. 1, the LPDN system 100 includes LPDN server 120 and user interface 139 operating on officer access device 130. The user interface 139 may be a web browser such as Microsoft Internet Explorer®, an independent application running on the officer access device 130, or a mobile “app” running on one of the officer access devices 130 and driver mobile devices 140. In this embodiment, the present invention provides for the notification of drivers based on driver profiles stored in the registry database, which may be a subscriber database 123 co-located with the LPDN server 120 or may be a separate agency-maintained database (e.g., state department of transportation “DOT”) accessible via a communications network, e.g., database 114 housed in a license database and/or as stored in a separate third-party provided database 116. The registry databases 114 and 116 may be stored on or accessed by a database server 112.

Database 110 may comprise a combination of internal, external, and/or third-party databases. For example, multiple states participating in the LPDN-based service may share or exchange driver information to allow for a broader cross jurisdiction notification system. For example, if a Kentucky driver is stopped by an officer in Indiana and both jurisdictions provide LPDN-based services, then an Indiana officer may contact the Kentucky driver subscribing or otherwise participating in the LPDN service. The database server 112 may also include additional databases relating to subscriber information, mapping information, and vehicle video recording systems to provide enhanced services. The other databases may be accessible for use by system 100 to manage and track driver notifications. Interactions between police and drivers may, alternatively, be recorded for later replay.

Databases 110, which take the exemplary form of one or more electronic, magnetic, or optical data-storage devices, include or are otherwise associated with respective indices (not shown). Each of the indices includes terms and phrases in association with corresponding document addresses, identifiers, and other conventional information. Databases 110 are coupled or couplable via a wireless or wireline communications network, such as a local-, wide-, private-, or virtual-private network, to server 120.

Server 120, which is generally representative of one or more servers for providing LPDN functionality through one or more service modules to officers and drivers. More particularly, server 120 includes a processor module 121, a memory module 122, a subscriber database 123, a driver database 124, an LPDN (e.g., “YUSTOPME service interface) 125, and a “other jurisdictions interface 126. Processor module 121 includes one or more local or distributed processors, controllers, or virtual machines. Memory module 122, which takes the exemplary form of one or more non-transitory electronic, magnetic, or optical data-storage devices, stores a subscriber database 123, which may be loaded from an external database such as driver/notification database 116, a driver database 124, an LPDN (e.g., “YUSTOPME” service interface) 125, and a “other jurisdictions interface 126. The YUSTOPME service interface 125 comprises a set of commands and functions for managing driver notification services by the LPDN system. The “Other Jurisdictions Interface” module 126 comprises a set of commands and functions that facilitate interaction of LPDN system 100 with LPDN systems operated by other jurisdictions (e.g., other states or cities or counties) which may be stored locally in the server 120 or may be loaded from the database server 112. The Subscriber Database 122 may comprise registry capabilities to directly enroll drivers into the LPDN system and may comprise a set of commands and functions that implement registry and management functionality although this may be handled via separate agency functions, e.g., DOT.

Subscriber database 123 is an optional component of the sever 120 and may include subscriber-related data for controlling, administering, and managing membership or subscription-based access of databases 110. In the exemplary embodiment, subscriber database 123a includes one or more user preference (or more generally user) data structures. In the exemplary embodiment, one or more aspects of the user data structure relate to user customization of various communication and interface options stored as user stored data 1231. User data 1231 also includes user ID 1231A, subscription data 1231B, user preferences 1231C, and external user stored data 1231E. LPDN server 120 may include one or more search engines and related user-interface components, for receiving and processing user queries against one or more of databases 110.

Still with reference to FIG. 1, officer access device 130 is generally representative of one or more access devices operated by officer responsible for traffic control or patrol. In the exemplary embodiment, access device 130 takes the form of a personal computer, workstation, personal digital assistant, mobile telephone, or any other device capable of providing an effective user interface with a server or database. Specifically, access device 130 includes a processor module 131, a memory 132, a display 133, a keyboard 134, and a graphical pointer or selector 135. In the exemplary embodiment, processor module 131 takes any convenient or desirable form and includes one or more processors, processing circuits, or controllers. Coupled to processor module 131 is memory 132. Memory 132 stores code (machine-readable or executable instructions) for an operating system 136, a browser 137, and scheduling and management software 138. In one exemplary embodiment, operating system 136 takes the form of a version of the Microsoft Windows operating system, and browser 137 takes the form of a version of Microsoft Internet Explorer. Operating system 136 and browser 137 not only receive inputs from keyboard 134 and selector 135, but also support rendering of graphical user interfaces on display 133. In some embodiments, display 133 may be a touch-screen display and may also serve to receive user inputs. Upon executing LPDN application 138 by processor 131, a LPDN interface 1392 integrated into the graphical-user interface 139 of the application software 138 is defined in memory 132 and rendered or presented on display 133. Upon rendering, interface 139 presents data in association with one or more interactive control features (or user-interface elements) which is stored in memory as API 1382. The LPDN interface 1392 may also be loaded into the user interface 139 of the browser 137.

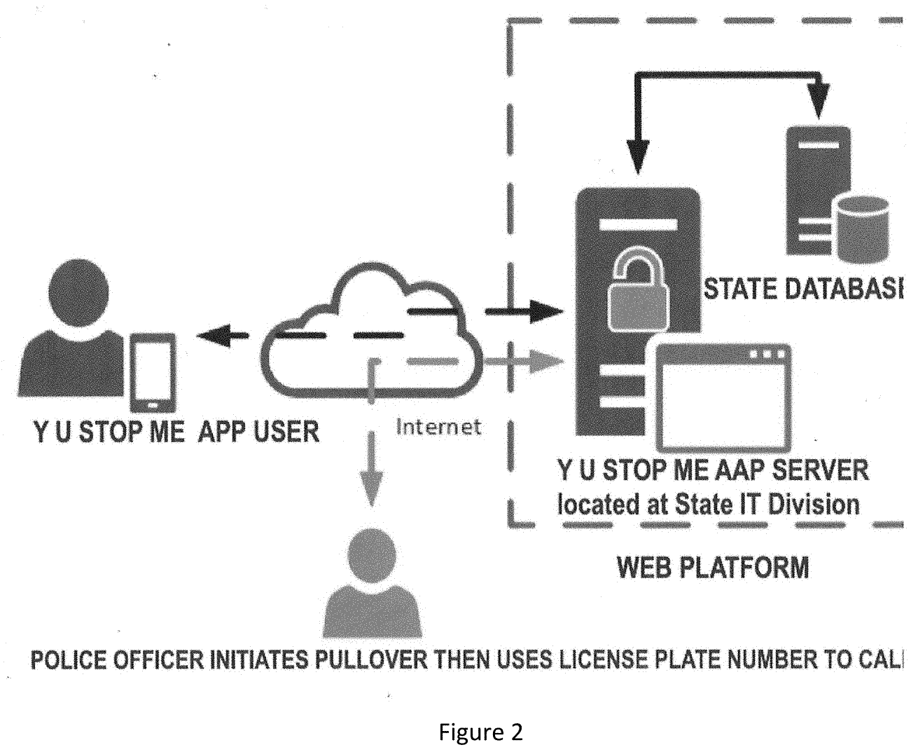

With reference now to FIG. 2, an exemplary embodiment of the LPDN system 100 is shown having a central state database, e.g., state license agency, connected to a server for deploying a web-based driver notification system. The system is managed, e.g., by a state or other governmental agency, e.g., police department, and is connected via a communications network to a police officer operating a remote access device, such as a remote device in the possession of an officer or fixed to a police cruiser. When a police officer pulls over a motorist the officer inputs the vehicle license information over a communications network to access a database to determine if the vehicle and an associated owner of the vehicle is registered to the LPDN system. A database lookup is initiated to see if the license tag matches a driver record stored on the database. If a match is found then the officer is presented with contact information to contact the owner of the vehicle and presumed operator of the vehicle. The office or central server contacts the owner of the vehicle based on information and permissions given by the owner and included in the owner profile data structure. The owner is contacted, e.g., by a phone call from the officer or a text from the officer or by similar means from the central server facility. For example a dispatcher may initiate the call instead of the officer and may report back to the officer whether the vehicle is associated with a record stored in the LPDN database.

The driver or owner of the vehicle is contacted and alerted to the fact the person pulling them over is in fact an officer associated with a state or other agency of the government. The contact may be a phone call directly from the officer operating the police vehicle involved in the traffic stop and the communication may be direct between the officer and the owner of the vehicle. If the owner is operating the vehicle being pulled over then there is direct communication between the driver and officer. The officer then communicates to the driver the reason for the stop, e.g., speeding, traffic light, stop sign infraction or other event. This gives the driver a way of confirming the purpose and authorized nature of the traffic stop. The LPDN may also track the event, i.e., traffic stop, along with driver/officer interaction. This will help to deescalate and remove tension associated with what can be a stressful event.

In the event the owner associated with the vehicle is not the driver, then the owner may confirm the person who has possession of the vehicle and the authorized nature of the possession or not. The record associated with the vehicle may also include an other authorized user, e.g., a family member, and may also include contact information for other authorized operators. The record may also include other pertinent information including health or other issues associated with the owner or authorized driver.

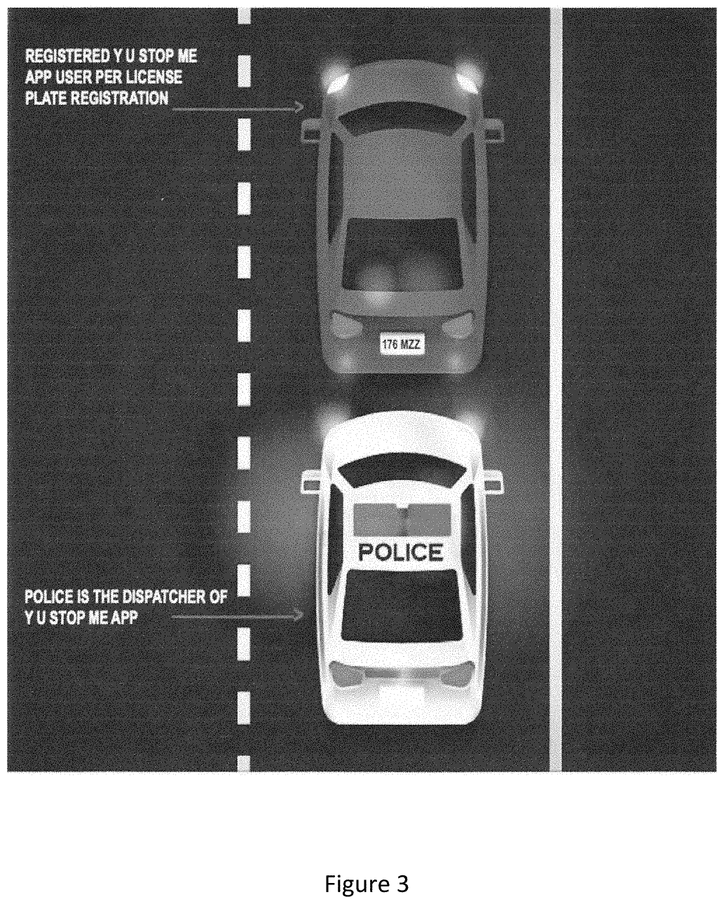

With reference now to FIG. 3, an illustration showing a police officer pulling over a vehicle and driver during a typical traffic stop and shows the police officer and/or dispatcher as operating the LPDN (YUSTOPME) application to reach out to a registered owner/operator of the stopped vehicle. The officer inputs the license tag of the vehicle or calls in the information to a dispatcher. Either the officer or the dispatcher checks the LPDN database to see if the vehicle is registered and if so accesses the contact information provided by the owner/operator. The LPDN information and subscriber record may be part of the vehicle registration process or licensing process to facilitate participation.

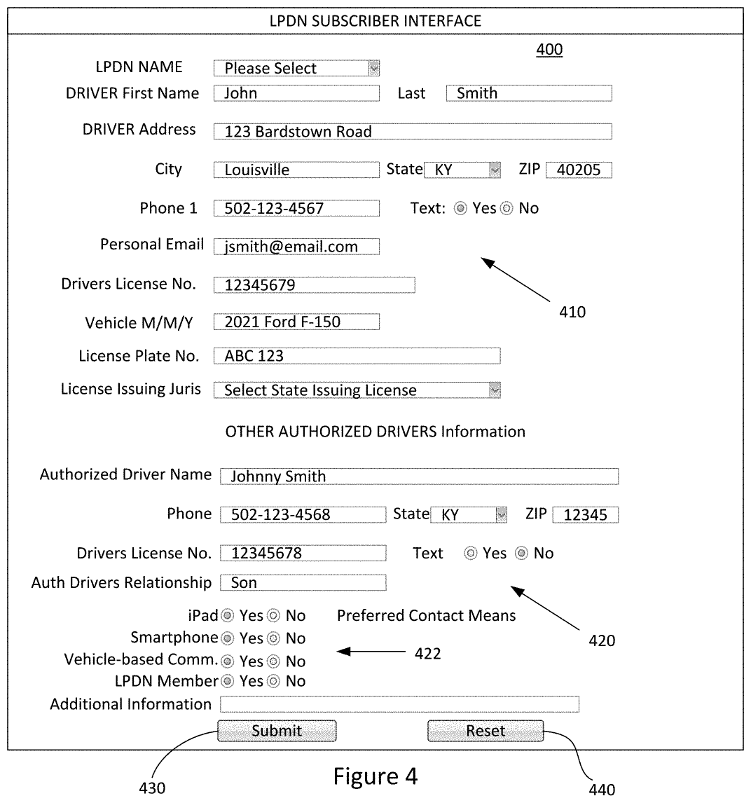

With reference now to FIG. 4, a screenshot of an embodiment of a LPDN subscriber interface 400 according to the present invention is provided. The LPDN subscriber interface 400 allows an administrator to add an owner/driver to the LPDN system and database or an associated database. The owner's personal information is entered in the personal information fields 410 and may include first and last name, address, city, state, and zip code, phone number, if texts are available, personal email, vehicle license tag/number, vehicle type, owner driver's license number, and state issuing license tag and/or driver's license. Additional other authorized driver information fields 420 are provided and may include name, address, city, state, and zip code, driver's license number, relationship, and other data. In the additional information fields 422, information such as the availability of an iPad, smartphone, vehicle-based communication, and LPDN membership information may be indicated. The fields 420 and 422 may also be provided to the officer or may only visible by a displatcher.

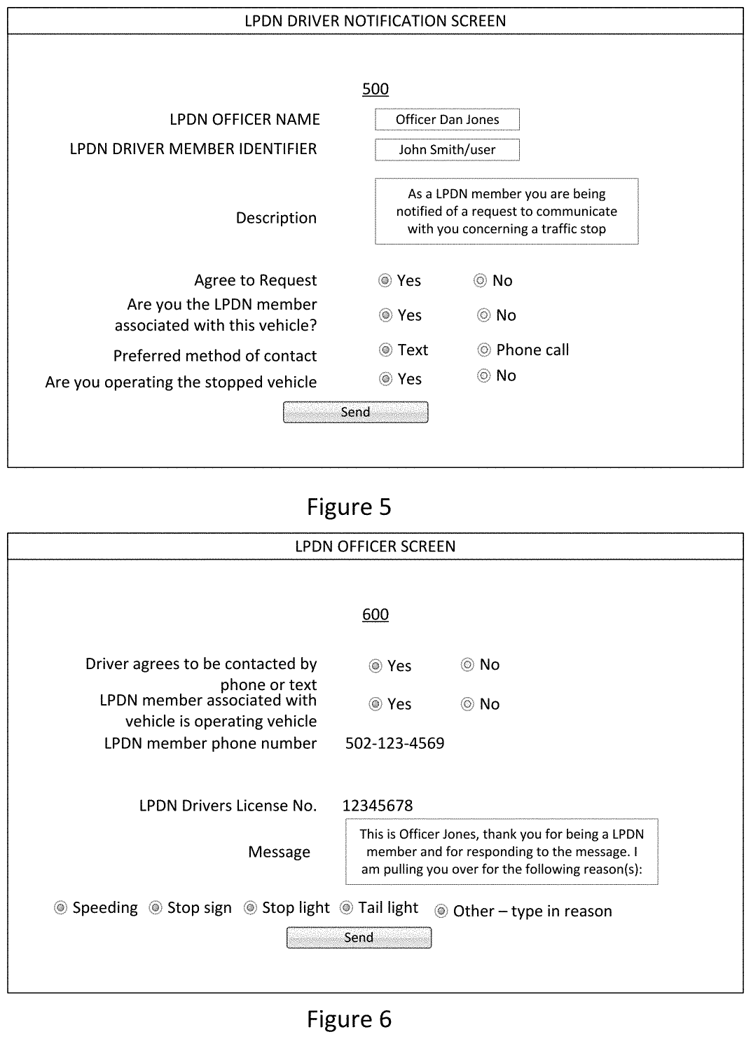

With reference now to FIGS. 5 and 6, screenshots of embodiments of an LPDN Driver Notification interface 500 and LPDN Officer Interface 600 according to the present invention are provided. In this example screen 500 presents the owner/operator with the office name and presents a message “As a LPDN member you are being notified of a request to communicate with you concerning a traffic stop.” The owner/operator may respond with agreeing to the request, confirming they are actually operating the stopped vehicle, and preferred contact method.

As shown at FIG. 5, the officer is presented with an interface screen confirming the driver's identity, that they agree to communicate with the officer via the LPDN system, the phone number of other contact data, the LPDN driver's license number and allowing the officer to communicate a message, e.g., text message concerning the reason for the stop.

The present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

What is claimed is:

1. A Police Driver Notification system (“LPDN”) in communication with one or more databases, and comprising:
a driver and vehicle registry database adapted to store a plurality of driver profiles, each driver profile associated with a licensed driver, a driver identification, a vehicle, a driver mobile device, and a vehicle license assigned to the vehicle;
an LPDN server comprising a processor, a memory, and a communications interface adapted to communicate over one or more communications networks with: a set of law enforcement (“officer”) access devices; and a set of driver mobile devices, wherein each driver mobile devise is associated with a corresponding driver account stored in the driver registry database;
the LPDN server adapted to store and serve an officer user interface for operating on the officer access devices and driver user interface for operating on the driver mobile access devices;
wherein during a traffic stop an officer utilizes the officer user interface to access the LPDN system, input a stopped vehicle license plate identification, and determine, by the driver and vehicle registry database, an associated driver mobile device registered for use with the LPDN system and establish a communication by using the number associated with the registered driver mobile device to communicate directly with the driver of the stopped vehicle without exiting a police vehicle or requiring the driver to exit the stopped vehicle.

2. The LPDN system of claim 1, wherein one or both of the officer user interface and driver user interface is a web browser such as Microsoft Internet Explorer®, an independent application running on the officer access device, or a mobile “app” running on one or both of the officer access devices and the driver mobile devices.

3. The LPDN system of claim 1, wherein the registry database comprises either a subscriber database co-located with the LPDN server or a separate agency-maintained database accessible via a communications network.

4. The LPDN system of claim 1, wherein the LPDN system is a web-based or cloud-based software-as-a-service (SaaS) system accessed via a network by the officer access devices and driver mobile devices.

5. The LPDN system of claim 1, wherein the registry database comprises a combination of internal, external, and/or third-party databases, wherein multiple state jurisdictions participating in the LPDN-based service may share or exchange driver information to allow for a broader cross jurisdiction notification system.

6. The LPDN system of claim 1, further comprising additional databases relating to subscriber information, mapping information, and vehicle video recording systems to provide enhanced services, and wherein the other databases may be accessible for use by system to manage and track driver notifications, and wherein interactions between police and drivers may be stored and recorded for replay.

7. The LPDN system of claim 1, wherein the registry databases comprises one or more electronic, magnetic, or optical data-storage devices, include or are otherwise associated with respective indices, wherein each of the indices includes terms and phrases in association with corresponding document addresses, identifiers, and other conventional information.

8. A LPDN central server comprising one or more service modules to officers and drivers and comprising:
a communications interface;
a processor for executing instructions;
a memory configured to store executable instructions for execution by the processor;
a database adapted to store subscription, driver, and vehicle information;
an LPDN service interface module; and
an other jurisdiction interface;
wherein the LPDN service interface comprises a set of commands and functions for managing driver notification services by the LPDN system; and
wherein the other jurisdiction interface comprises a set of commands and functions that facilitate interaction of LPDN system with LPDN systems operated by other jurisdictions;
wherein during a traffic stop an officer utilizes the officer user interface to access the LPDN system, input a stopped vehicle license plate identification, and determine, by the driver and vehicle registry database, an associated driver mobile device registered for use with the LPDN system and establish a communication by using the number associated with the registered driver mobile device to communicate directly with the driver of the stopped vehicle without exiting a police vehicle or requiring the driver to exit the stopped vehicle.

9. A method for facilitating communications between a police officer and a driver during a traffic stop, the method comprising:
a police officer pulling over a vehicle and driver during a traffic stop;
the police officer and/or dispatcher operating a LPDN application to reach out to a registered owner/operator of the stopped vehicle;
confirming with the driver the stop is associated with an officer;
the officer inputs the license tag of the vehicle or calls in the information to a dispatcher;
either the officer or the dispatcher checks the LPDN database to see if the vehicle is registered;
the officer accesses the contact information provided by the owner/operator;
the officer establishes a communication with the driver associated with the vehicle to confirm nature of traffic stop and confirm identity of officer.
